(19) United States
(12) Patent Application Publication
(10) Pub. No.: US 2011/0120569 A1
(43) Pub. Date: May 26, 2011

(54) Fuel Tank System For Gasoline And Flexible Ethanol Powered Vehicles Using On-Demand Direct Ethanol Injection Octane Boost

(75) Inventors: Leslie Bromberg, Sharon, MA (US); Daniel Cohn, Cambridge, MA (US)

(73) Assignee: ETHANOL BOOSTING SYSTEMS, LLC, Cambridge, MA (US)

(21) Appl. No.: 12/951,377

(22) Filed: Nov. 22, 2010

Related U.S. Application Data
(60) Provisional application No. 61/263,426, filed on Nov. 23, 2009.

(51) Int. Cl. G05D 11/00

(52) U.S. Cl. 137/98

(57) ABSTRACT

A fuel tank system for gasoline or flexible gasoline/ethanol powered vehicles that use independently controlled direct ethanol injection to provide a large on-demand octane boost is disclosed. The on-demand octane boost is used when needed to prevent knock. The ethanol can be in the form of 100% ethanol or E85 (a 85% ethanol, 15% gasoline mixture) and is stored in a second tank that is separate from the tank that which contains the primary fuel. The primary fuel can be gasoline, E85, ethanol or a mix of these fuels. The fuel tank system enables convenient, quick, flexible and minimal cost refueling of the separate fuel tank. A range of fueling options is available to provide the driver with the maximum freedom to choose fuels depending upon price and availability. Valves may be utilized to direct the flow in fuel to the various tanks.

This application claims priority of U.S. Provisional Patent Application No. 61/263,426, filed Nov. 23, 2009, the disclosure of which is incorporated herein by reference in its entirety.

### BACKGROUND

Increasing concerns about global climate change and energy security call for cost effective new approaches to reduce use of fossil fuels in cars and other vehicles. Recent domestic legislation, as well as the Kyoto protocol for greenhouse gas reduction, set challenging goals for reduction of CO₂ emissions. For example, the California legislation phases in requirements for reducing CO₂ generation by 30% by 2015. Other states may follow California in establishing lower emission goals. While new technologies, such as electric vehicles, are being pursued, cost effective approaches using currently available technology are needed to achieve the widespread use necessary to meet these aggressive goals for reduced fossil fuel consumption. Ethanol biofuel could play an important role in meeting these goals by enabling a substantial increase in the efficiency of gasoline engines.

One method of improving traditional gasoline engine efficiency is through the use of high compression ratio operation, particularly in conjunction with smaller sized engines. The aggressive turbocharging (or supercharging) of the engine provides increased boosting of naturally aspirated cylinder pressure. This pressure boosting allows a strongly turbocharged engine to match the maximum torque and power capability of a much larger engine. Thus, the engine may produce increased torque and power when needed. This downsized engine advantageously has higher fuel efficiency due to its low friction, especially at the loads used in typical urban driving.

Engine efficiency can also be increased by use of higher compression ratio. Compression ratio is defined as the ratio of the total volume of the cylinder when the piston is at the bottom of its stroke, as compared to its volume when the piston is at the top of its stroke. Like turbocharging, this technique serves to further increase the pressure of the gasoline/air mixture at the time of combustion.

However, the use of these techniques is limited by the problem of engine knock. Knock is the undesired rapid gasoline energy release due to autoignition of the end gas, and can damage the engine. Knock most often occurs at high values of torque, when the pressure and temperature of the gasoline/air mixture exceed certain levels. At these high temperature and pressure levels, the gasoline/air mixture becomes unstable, and therefore may combust in the absence of a spark.

Octane number represents the resistance of a fuel to autoignition. Thus, high octane gasoline (for example, 93 octane number vs. 87 octane number for regular gasoline) may be used to prevent knock and allow operation at higher maximum values of torque and power. Additionally, other changes to engine operation, such as modified valve timing may also help. However, these changes alone are insufficient to fully realize the benefits of turbocharging and higher compression ratio.

The use of higher octane fuels can reduce the problem of knocking. For example, ethanol is commonly added to gasoline. Ethanol has a blending octane number of roughly 110, and is attractive since it is a renewable energy source that can be obtained using biomass. Many gasoline mixtures currently available are about 10% ethanol by volume. However, this introduction of ethanol does little to affect the overall octane of the mixture. Mixtures containing higher percentages of ethanol, such as E85, suffer from other drawbacks. Specifically, ethanol is more expensive than gasoline, and is much more limited in its supply. Thus, it is unlikely that ethanol alone will replace gasoline as the fuel for automobiles and other vehicles. Other fuels, such as methanol, also have a higher blending octane number, such as 130, but suffer from the same drawbacks listed above.

The direct injection of an anti-knock fluid having alcohol content (such as ethanol or methanol) into the cylinder has a stabilizing effect on the gasoline/air mixture and reduces the possibility of knocking. In some embodiments, the anti-knock fluid may also include gasoline and/or water. FIG. 5 shows a representative boost system.

As described in U.S. Pat. Nos. 7,314,033 and 7,225,787, the on-demand octane boost provided by independent direct ethanol injection can enable high fuel economy by essentially removing the knock limit on engine performance and thereby allowing the use of small, highly turbocharged and high compression ratio engines as a replacement for much larger displacement engines. These small engines can operate with considerably higher efficiency while providing the same or better performance than larger engines.

This capability makes high fuel economy possible at relatively low cost in:
1. Gasoline Powered Vehicles—These vehicles use a minimal amount of ethanol that is directly injected and independently controlled The amount of ethanol or E85 required for the separate tank for on-demand octane boost is typically on the order of only 4 to 20 gallons/yr when the vehicle is essentially powered by gasoline. This small amount of ethanol for 50 million vehicles would require less than 1 billion gallons of ethanol per year, which is about 25% of present US ethanol production and about 13% of the anticipated ethanol production in 5 years. In these vehicles, the ethanol or E85 refill interval could be 3 months or more. This refueling interval makes it possible for the ethanol or E85 to be added by a mechanic at the same time that the oil is changed as part of routine servicing. Alternatively, the driver could add ethanol or E85 at any time using 1 to 5 gallon containers or by use of an E85 pump once every few months.
2. Flexible Gasoline/Ethanol Fueled Vehicles—These vehicles are capable of operating over the entire range of ethanol/gasoline fuel mixtures from close to 100% gasoline to 100% ethanol. Independent direct ethanol injection is used to remove the knock limit when the gasoline/ethanol mixture in the first fuel tank does not have sufficient ethanol to prevent knock. The use of ethanol as a substitute fuel for gasoline in flexible fuel vehicles is likely to increase with the substantial increase in the E85 infrastructure that is planned as part of the 2005 Energy Act.

The representative boost system 100, shown in FIG. 5, includes a spark ignition engine 105, in communication with a manifold 110. The manifold 110 receives compressed air from turbocharger 120, and gasoline from primary fuel tank 130. The gasoline and air are mixed in the manifold 110, and enter the engine 105, such as through port fuel injection. A second Octane Boost tank 140 is used to hold anti-knock, or octane boost, fluid, which enters the engine 105 through direct injection. Additionally, the boost system 100 includes a knock sensor 150, adapted to monitor the onset of knock. The system also includes a boost system controller 160. The boost system controller receives an input from the knock sensor 150, and based on this input, controls the release of anti-knock fluid from the Octane Boost tank 140 and the release of gasoline from the primary fuel tank 130. In some embodiments, the boost system controller 160 utilizes open loop control to determine the amount of gasoline and octane boost fluid to inject into the engine 105. In another embodiment, a closed loop algorithm is used to determine the amount of octane boost fluid, based on the knock sensor 150, and such parameters as RPM and torque.

Ethanol has a high fuel octane number (a blending octane number of 110). Moreover, appropriate direct injection of ethanol, or other alcohol-containing anti-knock fluids, can provide an even larger additional knock suppression effect due to the substantial air charge cooling resulting from its high heat of vaporization. Calculations indicate that by increasing the fraction of the fuel provided by ethanol up to 100 percent when needed at high values of torque, an engine could operate without knock at more than twice the torque and power levels that would otherwise be possible. The level of knock suppression can be greater than that of fuel with an octane rating of 130 octane numbers injected into the engine intake. The large increase in knock resistance and allowed inlet manifold pressure can make possible a factor of 2 decrease in engine size (e.g. a 4 cylinder engine instead of an 8 cylinder engine) along with a significant increase in compression ratio (for example, from 10 to 12). This type of operation could provide an increase in efficiency of 30% or more. The combination of direct injection and a turbocharger with appropriate low rpm response provide the desired response capability.

Because of the limited supply of ethanol relative to gasoline and its higher cost, and to minimize the inconvenience to the operator of refueling a second fluid, it is desirable to minimize the amount of ethanol, or alcohol-based anti-knock fluid, that is required to meet the knock resistance requirement. By use of an optimized fuel management system, the required ethanol energy consumption over a drive cycle can be kept to less than 10% of the gasoline energy consumption. This low ratio of ethanol to gasoline consumption is achieved by using the direct ethanol injection only during high values of torque where knock suppression is required and by minimizing the ethanol/gasoline ratio at each point in the drive cycle. During the large fraction of the drive cycle where the torque and power are low, the engine would use only gasoline introduced into the engine by conventional port fueling. When knock suppression is needed at high torque, the fraction of directly injected ethanol is increased with increasing torque. In this way, the knock suppression benefit of a given amount of ethanol is optimized.

In one embodiment, an anti-knock fluid, such as an alcohol (such as ethanol or methanol) or alcohol blend with water and/or gasoline, is kept in a container separate from the main gasoline tank. As shown in FIG. 2, octane boost fluid from a small separate fuel tank is directly injected into the cylinders (in contrast to conventional port injection of gasoline into the manifold). The concept uses the direct fuel injector technology that is now being employed in production gasoline engine vehicles. The traditional path used by the gasoline is maintained, and is used to aspirate the gasoline prior to its injection into the cylinder. In situations where knocking may occur, such as high torque or towing, the anti-knock fluid is injected directly into the cylinder. The high heat of vaporization of the boost gas reduces the temperature of the gasoline/air mixture, thereby increasing its stability. In situations where knocking is not common, such as normal highway driving, the anti-knock fluid is not used. Thus, by limiting the use of the anti-knock fluid to only those situations where knocking is prevalent, the amount of anti-knock fluid used can be minimized.

By directly injecting the anti-knock fluid into the cylinder, knocking can be significantly reduced. This allows boost ratios of 2 to 3 and compression ratios in the 11 to 14 range. A fuel efficiency increase of 20%-30% relative to port fuel injected engines can be achieved using these parameters. Alcohol boosting can provide a means to obtain rapid penetration of high efficiency engine technology in cars and light duty trucks.

However, there is a need to fill two separate fuel tanks, primary fuel tank 130 and octane boost tank 140. Doing so may present a challenge to consumer, who must remember to supply the proper fuel to each port of the vehicle. Confusion about which fuel should be used may have adverse consequences. For example, using ethanol to fill the primary fuel tank 140 may be very costly.

Therefore, it would be beneficial if there existed a flexible tank system that helped automate the filling process, and also properly accommodated various fluid level conditions. The inconvenience to the driver of having to carry out a special fill up of the octane boost tank would be minimized or in some cases virtually eliminated if it could be filled up every time that ethanol were used in the main tank.

### SUMMARY OF THE INVENTION

This disclosure describes a fuel tank system for gasoline or flexible gasoline/ethanol powered vehicles that use independently controlled direct ethanol injection to provide a large on-demand octane boost. Another embodiment is independently controlled port fuel injection of fluid from the one boost tank. The on-demand octane boost is used when needed to prevent knock. The ethanol can be in the form of 100% ethanol or E85 (a 85% ethanol, 15% gasoline mixture) and is stored in a second tank that is separate from the tank that which contains the primary fuel. The primary fuel can be gasoline, E85, other forms of ethanol or various mixtures of ethanol and gasoline. The fuel tank system enables convenient, quick, flexible and minimal cost refueling of the separate fuel tank. A range of fueling options is available to provide the driver with the maximum freedom to choose fuels depending upon price and availability.

Key objectives are to enable high fuel economy at low cost in flexible gasoline/ethanol fueled vehicles and to facilitate maximum flexibility in terms of the types of fuels that can be used and in terms of the means by which refueling is carried out.

### BRIEF DESCRIPTION OF THE DRAWINGS

FIG. 1 is a fuel tank system according to one embodiment;

FIG. 2 is a fuel tank system according to one embodiment;

FIG. 3 is a fuel tank system according to one embodiment;

FIG. 4a is a fuel tank system according to one embodiment;

FIG. 4b is a fuel tank system according to one embodiment; and

FIG. 5 is a representative boost system.

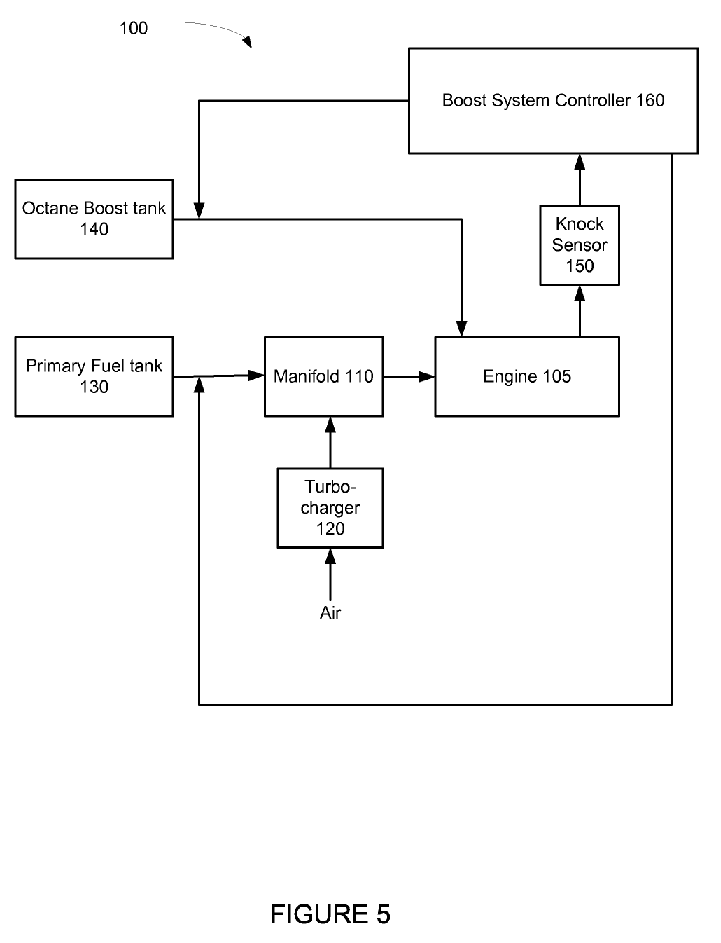

### DETAILED DESCRIPTION OF THE INVENTION

As described above, the fuel tank system of a boost system typically uses a second fuel tank as a source for independent direct injection of ethanol or E85, while a first tank contains gasoline, E85, ethanol, or a combination of these fuels. The second tank can be referred to as the “octane boost tank, and the first fuel tank as the “primary fuel tank”. Methanol can also be used in the second tank instead of ethanol or in addition to ethanol It can also be used in the primary fuel tank.

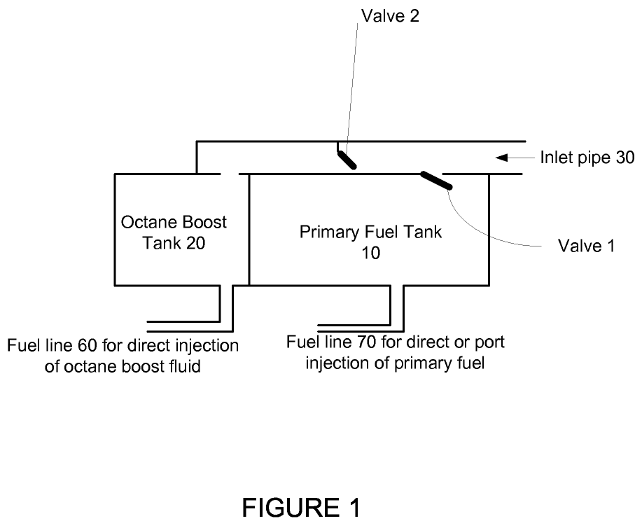

FIG. 1 shows a tank system in accordance with one embodiment. The two tanks may be formed as compartments of a single tank as shown in FIG. 1. Alternatively, the two tanks may be completely separate from each other.

As shown in FIG. 1, a valve system can be used to allow different options for filling the two tanks from a single fuel inlet pipe 30 that can accept fuel from a gasoline pump, an E85 pump, an E100 pump (E100 refers to 100% ethanol) or fuel from other sources, such as containers. The valve system may be a single valve or may include a plurality of valves, as shown in FIG. 1. The primary fuel tank 10 can be filled without filling the octane boost tank 20, using inlet pipe 30, by opening valve and closing valve 2. The octane boost tank 20 can be filled, using inlet pipe 30, without filling the primary tank 10 by closing valve 1 and opening valve 2. Both tanks can be filled with the same fuel such as E85, by opening both valves 1,2. The valves 1,2 can be controlled manually, such as by the switches which are activated by the driver. Alternatively, a difference in the nozzle size may be used to actuate the proper valve.

In some embodiments, a single valve may be used to control the flow of incoming fuel into one of the two tanks 10, 20. For example, in a first position, the valve may block the opening to the primary fuel tank 10, while in the second position, it may block fluid from traveling toward octane boost tank 20. In some embodiments, the valve may have a third position, between the first and second positions, wherein fuel may enter both tanks.

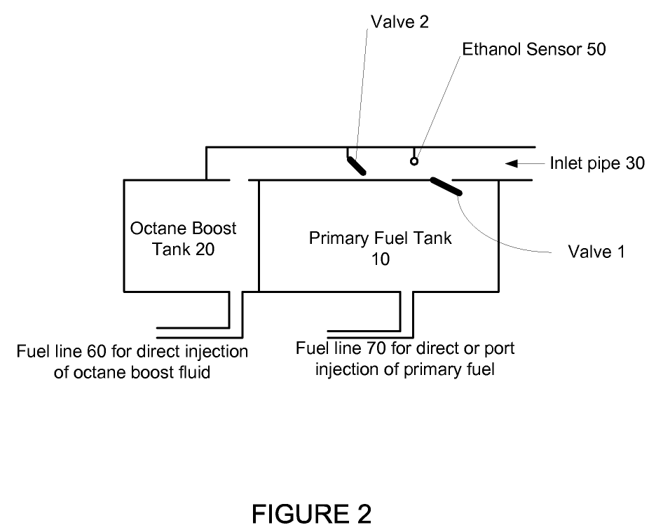

In another embodiment, shown in FIG. 2, an alcohol sensor 50 may be placed in a chamber in front of the valve 2 to the octane boost tank 20 to prevent accidental filling of the octane boost tank 20 with gasoline. The fuel tank system can be configured such that valve 1 will not open unless ethanol is detected in the chamber by alcohol sensor 50. Although the sensor 50 is termed an alcohol sensor, the sensor may be used to detect other fluids as well. The alcohol sensor 50 may be used to detect ethanol or methanol or water, or mixtures of these alcohols with or without water. In some embodiments, the presence of ethanol, as detected by the sensor 50, will also close valve 1. One sensor could also be used to detect methanol or, in some embodiments, a separate sensor (not shown) could also be employed, such that one is used to detect ethanol and the other is used to detect methanol.

The alcohol sensor 50 for detecting ethanol and/or methanol and/or water would be used in conjunction with a controller to determine whether the fuel introduced into the tank fill pipe had a sufficient concentration of alcohol (ethanol or methanol) to allow it to be introduced into the octane boost tank 20. In some embodiments, a minimum threshold may be set. For example, E85 would be allowed to enter the octane boost tank 20 where as E10 (10% ethanol, 90% gasoline) would not be allowed to enter. In one embodiment, the threshold is set such that the preferred ethanol concentration would be greater than E25 (25% ethanol, 75% gasoline), although other minimum concentrations are within the scope of the disclosure.

The minimum concentration threshold could either be determined by the driver during each fill or could be preset. In one embodiment, the threshold may allow a gasoline-alcohol fuel mixture with sufficient ethanol and/or methanol concentration to be introduced into the octane boost tank 20 as well as the primary tank 10 if the concentration of ethanol and or methanol were sufficiently high for use as an octane boost fluid.

Again, as described above, a single valve may be used to control the flow of incoming fuel into the two tanks.

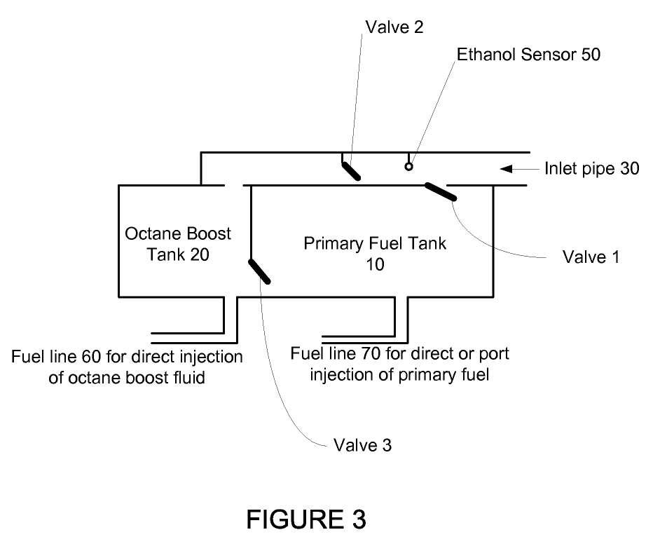

In another embodiment, shown in FIG. 3, further flexibility in the fuel tank design can be achieved by the addition of valve 3, which can directly connect the two tanks 10,20. In one instance, this valve 3 allows primary fuel to be moved from the primary fuel tank 10 to the octane boost tank 20, such as when there is no fluid in the octane boost tank 20.

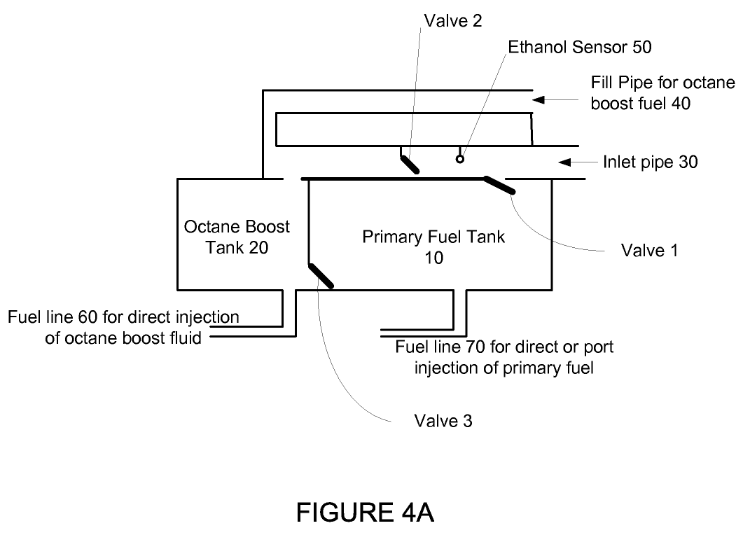

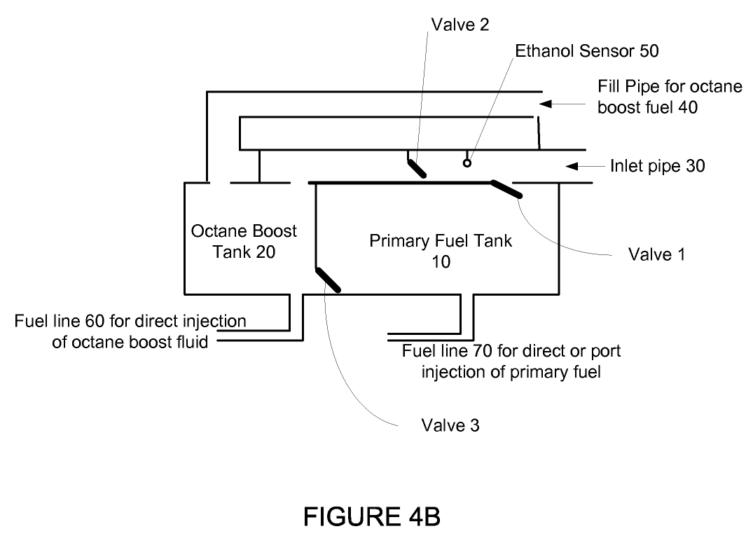

In other embodiments, shown in FIGS. 4a-b, a separate fuel inlet 40 exists for the octane boost tank 20. This fuel inlet 40 could be used for the introduction of ethanol fuel that contains water, thus avoiding problems that arise when such fuel is mixed with gasoline. The use of ethanol fuel that contains water may be attractive because the production of such fuel requires less processing than completely dewatered ethanol and its use can allow utilization of pipeline transport of ethanol. In addition, an alcohol-water mixture can have a greater octane boost effect than alcohol alone. In another embodiment, the octane boost fluid tank 20 is filled with water. This embodiment would be particularly effective with direct injection of water or a water-alcohol mixture into the engine.

In some embodiments, such as that shown in FIG. 4B, the separate fuel inlet 40 leads to a different opening in the second tank. This is to minimize the number of components, which may be in contact with both gasoline and water.

The same fuel injectors used for the independent direct E85 or ethanol injection from the octane tank could also be used for the injection of gasoline or E85 from the larger tank. In another embodiment, the octane boost fluid is introduced into the engine using port fuel injection that is independently controlled from the introduction of fuel from the primary fuel tank 10. The fuel from the primary fuel tank 10 could be port injected using a separate fuel injector.

An air/fuel mixture control system would be used to provide substantially stoichiometric operation both during the time that the on-demand direct injection octane boost is used and when flexible fuel operation with ethanol or E85 in the primary tank is employed. Stoichiometric operation makes it possible to use a three way catalytic converter which is highly effective in reducing emission of pollutants in the engine exhaust.

The fuel tank system can be used to allow knock free operation in very high compression ratio engine with a compression ratio of 14 or greater. The engine can be either naturally aspirated or turbocharged.

The octane boost tank 20 can be sized so that the refill interval for the octane boost tank 20 can generally be as long as three or more months. An illustrative case is a total fuel tank capacity of 22 gallons with a capacity of 6 gallons for the octane boost fuel compartment 20 and 16 gallons in the primary fuel tank compartment 10. Because of the increased fuel efficiency from the on-demand direct injection octane boost, this 16 gallon primary fuel tank 10 configuration would not lead to any decrease in range relative to a conventional 20 gallon gasoline tank.

The required amount of ethanol or E85 to provide the on demand octane boost for a 20 to 30% improvement in fuel economy is between 1 and 5 gallons for every 100 gallons of gasoline. Assuming an illustrative annual gasoline consumption rate of 400 gallons a year (12,000 miles/yr at 25 miles per gallon), the ethanol or E85 consumption rate is between 4 and 20 gallons a year, corresponding to 0.3 to 1.7 gallons/month. For a consumption rate of 1.5 gallons/month, the use of a 6 gallon tank could allow for an E100 (100% ethanol) or E85 refill interval of up to 4 months.

E85 or E100 can be provided by pumps or by containers. 1 to 5 gallon containers can be used. Appropriate spouts can be used for ease of pouring.

The use of E100 rather than E85 as a primary fuel is possible because of the flexibility of being able to use gasoline for cold start that is available with the two tank system. For example, E100 may be used in the primary fuel tank 10, while gasoline is used in the smaller octane boost tank 20.

Methanol in various forms, such as M85 (85% methanol and 15% gasoline), can also be used in addition to or instead of E100 or E85.

With E85 or ethanol comprising part, or even all of the fuel in the primary fuel tank 10, the need for E85 or ethanol from the on demand octane boost fuel tank 20 to prevent knock would be reduced. Hence, the rate of use of E85 or ethanol from the on-demand octane boost fuel tank 20 could be accordingly reduced and the refill interval for this tank 20 could thus be extended. The reduction in fuel use from the octane boost tank 20 could be controlled by a computer map of engine performance in combination information about the ethanol concentration in the primary fuel tank 10 that is provided by an ethanol sensor or by a control system that uses signals from knock sensors.

Control of turbocharging can also be used to prevent knock when there is no fuel in the octane boost tank 20. The reduction in turbocharging may be determined based on the amount of fuel in the octane boost tank 20. Alternatively, if there is not ethanol in the octane boost tank 20, the reduction of the turbocharging level could be determined by a signal from an ethanol sensor in the primary fuel tank 10.

The amount of E85 or ethanol drawn from the octane boost fuel tank 20 could also be reduced by a control system that is activated by the driver. In this case, the turbocharging, power and horsepower capability would be decreased in order to reduce the demand for E85 or ethanol needed to insure knock free operation. This “octane boost economy” mode could also increase the refuel time interval and/or reduce the amount of E85 or ethanol that would be need to be added at any time to the octane boost tank 20.

The presence of two fuel tanks 10, 20 also makes it possible to operate flexible fuel vehicles completely or partially on ethanol without having to fuel with E85 in order to provide the 15% gasoline concentration needed for cold start, The vehicle can be fueled with ethanol and with sufficient gasoline in one of the tanks so that gasoline concentration needed for cold start is available.

The fuel injectors used for the independent direct E85 or ethanol injection from the octane tank could also be used for the injection of gasoline or E85 from the primary tank.

Another option for providing convenient pump refueling is to use a single spigot. In order to make it transparent to the driver, a single spigot with dual lines to the refueling station could be used to simultaneously fill both the primary fuel tank and the octane boost tank. Such a system is similar to that proposed by Ford for urea refueling for an SCR exhaust aftertreatment catalyst. An ethanol/gasoline dual spigot would be used instead of a diesel/urea dual fuel spigot.

It can also be possible to use a single spigot that refuels both the primary fuel tank 10 and the on-demand octane boosting tank 20 where the vehicle determines how much of each fuel is needed, and the refueling station adjusts the rate and amount of fuel that is introduced into the vehicle. In this case, the car, such as by using a processing unit or control system, automatically determines how much primary fuel and octane boost fuel is currently available, and how much is needed, assuming a pattern of driving that could include an onboard expert system that analyzes previous driving patterns.

The system can be arranged so that the onboard fuel management system reconfigures the fuel tank, adjusting the size of the respective tanks 10,20 in order to provide the appropriate ratio of octane boosting fuel to primary fuel, with the passive refueling system just filling both tanks to capacity. This can be achieved either with a single spigot with dual fuel dispensers, separated feeds, or single feed with a valve to switch the tank being refueled. This would be particularly useful for those engine designs and/or driving patterns that require substantial amounts of octane boosting fuel.

The most transparent adjustment of the tank configuration (ratio of the capacities of the main fuel tank 10 and the on-demand octane boost tank 20) occurs if the operation is done automatically by the fuel management system. However, in some embodiments, the system may be most flexible if the operator can also adjust the ratio, overriding the instructions from the fuel management system, in order to best match future driving patterns (for example, before starting on a long trip with highway driving pattern, or, conversely, after a long drive and readjusting to city driving pattern).

The sensor may very useful when multiple fuels are commingled in the primary and octane boost tanks. As the EPA regulates both the main fuel and the fuel additives that are combusted in the engine, it can be important to maintain the fuel in the main tank and in the octane boost tank within specifications. This may be particularly important if the fuel contains methanol or water. The water and methanol concentration in the main tank may need to be controlled so as not to exceed the maximum allowed. Presently, in the case of methanol, the EPA regulates that the methanol concentration in gasoline/methanol blends has to be lower than 5.5% (including cosolvent). The issue of water has to do with the potential of phase separation between the different liquids in the tank.

When multiple fuels are introduced into the octane boost tank 20, the sensor can determine the quality/composition of the antiknock agent, in order to determine the amount that needs to be introduced to avoid knock. The amount of octane boost fluid that needs to be used can be determined in a number of ways, such as by sensing the liquid in the octane boost tank 20, by measuring what is introduced into the octane tank 20 together with knowledge of what is initially in the octane boost tank 20, or it can be determined by a knock sensor on the engine, introducing as little secondary fuel as needed to prevent knock.

The amount of octane boost, or antiknock, agent that needs to be injected also depends on the composition of the primary fuel, which varies as different blends are commingled. Thus, the sensor can be used to determine the composition of the fuel in the primary and secondary tanks, either by determine their composition at the time or by tracking the refueling history of the tank, or by using other sensors in the vehicle, such as the knock sensor and the oxygen sensor. Thus, although not shown in the Figures, separate sensors may be include in one or both of the tanks 10,20, in addition to the one shown in FIGS. 2-4.

The two tank fuel system with the valve and sensor system control system described for a spark ignition engine fueled with gasoline and ethanol could also be applied to other dual fuel engines. These engines could be operated with either spark or compression ignition. One such engine is an engine where diesel fuel is used in one of the tanks.

The system configuration discussed above can be employed for any engine which would be fueled with a first fuel stored in a first tank, and also with a second fuel stored in a second tank and would have a valve system to control the flow of fuel into the first and second tanks. It would includes an inlet pipe, wherein the inlet pipe is used to fill both said first and second tanks or to fill one of them without filling the other. The valve system can close off the opening to said second tank while said first tank is being filled with the first fuel. It can also close off the opening to said first tank while said second tank is being filled with the second fuel. A sensor system can be employed to prevent filling the first tank with the second fuel and second tank with the first fuel.

Although alcohols, gasoline and water have been mentioned as types of fuels being introduced into the tank system, other types of liquid fuels are meant to be included. For engines running in compression ignition modes or HCCI (Homogeneous Charge Compression Ignition) or its variants such as PCI (Partial Compression Ignition), RCCI (Reaction Controlled Compression Ignition) and other advanced ignition modes, engine operation using various groups of fuels and other liquids can be attractive. Groups of liquids whose members could be introduced into the fill pipe and directed by use of the valve and sensor system discussed above to either the first or second tank or to both tanks depending upon which member of the group is introduced include
diesel fuel and/or diesel fuel additives and/or biodiesel;
gasoline fuel and diesel fuel;
diesel fuel and/or alcohol and or methanol and/or water;
diesel fuel and/or alcohol and or methanol and/or water and/or gasoline; and
diesel fuel and urea or urea mixes.

One sensor or multiple sensors can be used to determine the composition of the liquid being introduced into the tank (liquid types such as diesel, biodiesel, diesel additives, gasoline, gasoline additives, alcohols, water or mixtures of the above), or the composition of each tank.

The terms and expressions which have been employed herein are used as terms of description and not of limitation, and there is no intention in the use of such terms and expressions of excluding any equivalents of the features shown and described (or portions thereof). It is also recognized that various modifications are possible within the scope of the claims. Other modifications, variations, and alternatives are also possible. Accordingly, the foregoing description is by way of example only and is not intended as limiting.

What is claimed is:

1. A fuel tank system for a spark ignition engine system fueled by a primary fuel stored in a first tank, and by an octane boost fluid stored in a second tank, comprising:
a valve system to control the flow of fuel into said first and second tanks and
a first fuel inlet pipe, wherein said inlet pipe is used to fill at least one of said first and second tanks.

2. The fuel tank system of claim 1, wherein fluid in said second tank is directly injected into the engine.

3. The fuel tank system of claim 1, wherein fluid in said second tank is introduced into the engine by port fuel injection.

4. The fuel tank system of claim 1, wherein aid first tank and said second tank are separate compartments formed from the same fuel tank.

5. The fuel tank system of claim 1, wherein said valve system closes off the opening to said second tank while said first tank is being filled.

6. The fuel tank system of claim 1, wherein said valve system closes off the opening to said first tank while said second tank is being filled.

7. The fuel tank system of claim 1, wherein said valve system allows both said first tank and said second tank to be filled at the same time.

8. The fuel tank system of claim 1, further comprising an alcohol sensor, wherein alcohol must be detected by said alcohol sensor before said valve system allows the flow of fuel into said second tank, wherein said alcohol comprises ethanol, methanol or a mixture of ethanol and methanol.

9. The fuel tank system of claim 8, wherein the alcohol concentration in the fuel that is introduced into said fuel inlet pipe must be above a minimum threshold before the fuel is allowed to flow into said second tank.

10. The fuel tank system of claim 9, wherein said threshold is manually determined by the driver at the time of fueling.

11. The fuel tank system of claim 9, wherein said threshold is preset to allow simultaneous filling of the first and second tank provided that the alcohol concentration in the fuel is sufficiently high.

12. The fuel tank system of claim 1, further comprising a second valve, wherein said second valve allows direct flow of fuel between said first tank and said second tank.

13. The fuel tank system of claim 1, wherein said second tank can be filled from a second fuel inlet pipe, different than said first fuel inlet pipe.

14. The fuel tank system of claim 13, wherein an alcohol-water mixture is introduced into said second tank through said second fuel inlet pipe

15. The fuel tank system of claim 13, wherein water is introduced into said second tank through said second fill pipe.

16. The fuel tank system of claim 15, wherein water from said second tank is directly injected into the engine.

17. The fuel tank system of claim 1, wherein said second tank contains ethanol or methanol.

18. The fuel tank system of claim 1, wherein said first tank contains gasoline, ethanol or a gasoline ethanol mixture.

19. The fuel tank system of claim 1, wherein E85 is introduced into said first fuel inlet pipe.

20. A fuel tank system for an engine, which is fueled with a first fuel stored in a first tank, and with a second fuel stored in a second tank, comprising:
a valve to control the flow of fuel into said first and second tanks, and
a first fuel inlet pipe, wherein said inlet pipe is used to fill at least one of said first and second tanks and
where one tank can be filled without filling the other tank
and further including a sensor system that determines whether the fuel that is introduced into the inlet pipe is introduced into the first tank, the second tank or both tanks.
